(19) United States
(12) Patent Application Publication
(10) Pub. No.: US 2020/0181462 A1
(43) Pub. Date: Jun. 11, 2020

(54) WATER-BASED PRESSURE SENSITIVE ADHESIVE COMPOSITIONS AND METHODS OF MAKING SAME

(71) Applicant: Rohm and Haas Company, Collegeviiie, PA (US)

(72) Inventors: Vinita Yadav, Royersford, PA (US); Josephine Eldredge, Norristown, PA (US); William B. Griffith, North Wales, PA (US)

(21) Appl. No.: 16/640,627

(22) PCT Filed: Jul. 17, 2018
(86) PCT No.: PCT/US2018/042423

§ 371 Date: Feb. 20, 2020

Related U.S. Application Data
(60) Provisional application No. 62/554,278, filed on Sep. 5, 2017.

(51) Int. Cl. C09J 7/38; C08F 220/18

(52) U.S. Cl. CPC C09J 7/385; C08F 2800/20; C09J 2433/00; C08F 220/1808

(57) ABSTRACT

Water-based pressure sensitive adhesive compositions are disclosed comprising an acrylic copolymer formed from a monomer mixture comprising, based on the total weight of monomers in the monomer mixture, (a) from 60 to 80 percent by weight 2-ethylhexyl acrylate, (b) from 10 to 30 percent by weight butyl acrylate, (c) from 3 to 7 percent by weight methyl methacrylate, (d) from 0.1 to 3 percent by weight styrene, (e) from 0.1 to 1 percent by weight (meth)acrylic acid, wherein the acrylic copolymer has an acid content of less than 1 percent by weight, based on the total weight of the monomers in the monomer mixture. Methods for preparing pressure sensitive adhesive compositions are also disclosed comprising preparing a monomer emulsion by dispersing a monomer mixture and a surfactant in an aqueous medium, and introducing an initiator to the monomer emulsion, thereby polymerizing the monomer mixture to form an acrylic copolymer suitable for use in a pressure sensitive adhesive composition.

### REFERENCE TO RELATED APPLICATIONS

The present application claims the benefit of U.S. Provisional Application No. 62/554,278, filed on Sep. 5, 2017.

### FIELD OF THE DISCLOSURE

The instant disclosure relates to pressure sensitive adhesive compositions. More particularly, the disclosure relates to water-based pressure sensitive adhesive compositions with improved adhesion and/or cohesion over a wide range of temperatures, and methods of making the same.

### BACKGROUND AND SUMMARY OF THE DISCLOSURE

Adhesive compositions are useful for a wide variety of purposes. One particularly useful subset of adhesive compositions is water-based pressure sensitive adhesives. The use of water-based pressure sensitive adhesives in different end-use applications is generally known. For instance, water-based pressure sensitive adhesives can be used with labels, tapes, decals, bandages, decorative and protective sheets, and a wide variety of other products. As used in the art, the term “pressure sensitive adhesive” designates a material comprising one or more polymer compositions which, when dried, is aggressively and permanently tacky at room temperature. Further, the term “water-based” indicates that the pressure sensitive adhesive is manufactured with an aqueous carrier. A typical water-based pressure sensitive adhesive will firmly adhere to a variety of dissimilar surfaces upon mere contact without the need of more than finger or hand-applied pressure.

Two properties recognized by the pressure sensitive adhesives industry are the adhesion (e.g., initial tack to a surface or adhesive force after a certain dwell time) and the cohesion (e.g., resistance to shear) of these polymer compositions. Attempts to improve the adhesive properties of pressure sensitive adhesives, such as by the addition of a tackifier to increase the glass transition temperature and decrease the modulus of the polymer composition, tend to reduce the resistance to shear, thereby promoting shear failure. The adhesive properties of water-based pressure sensitive adhesives are particularly important when the adhesives are to be used at various temperatures (e.g., room temperature and lower temperatures).

Therefore, water-based pressure sensitive adhesive compositions with improved adhesion and/or cohesion over a wide range of temperatures, and methods of making same, are desirable.

Water-based pressure sensitive adhesive compositions are disclosed comprising an acrylic copolymer formed from a monomer mixture. In some embodiments, the monomer mixture comprises, based on the total weight of monomers in the monomer mixture, (a) from 60 to 80 percent by weight 2-ethylhexyl acrylate, (b) from 10 to 30 percent by weight butyl acrylate, (c) from 3 to 7 percent by weight methyl methacrylate, (d) from 0.1 to 3 percent by weight styrene, (e) from 0.1 to 1 percent by weight (meth)acrylic acid, wherein the acrylic copolymer has an acid content of less than 1 percent by weight, based on the total weight of the monomers in the monomer mixture.

In some embodiments, the water-based pressure sensitive adhesive compositions further comprise a thickener, a defoamer, a wetting agent, a mechanical stabilizer, a pigment, a filler, a freeze-thaw agent, a neutralizing agent, a plasticizer, a tackifier, an adhesion promoter, and combinations thereof. In some embodiments, the water-based pressure sensitive adhesive compositions further comprise an acid selected from the group consisting of (meth)acrylic acid, itaconic acid, maleic acid, carboxylic acid, and combinations thereof. In some embodiments, the acrylic copolymer has a glass transition temperature of from −55 to −45° C.

Further, water-based pressure sensitive adhesive compositions an acrylic copolymer comprising, in a polymerized form a monomer having a relatively-low glass transition temperature of less than 0° C., a monomer having a relatively-high glass transition temperature of not less than 100° C., wherein the acrylic copolymer has an acid content of less than 1 percent by weight, based on the total weight of the monomers forming the acrylic copolymer.

Methods for preparing water-based pressure sensitive adhesive compositions are also disclosed. In some embodiments, the methods comprise preparing a monomer emulsion by dispersing a monomer mixture and a surfactant in an aqueous medium, the monomer mixture, based on the total weight of monomers in the monomer mixture, (a) from 60 to 80 percent by weight 2-ethylhexyl acrylate, (b) from 10 to 30 percent by weight butyl acrylate, (c) from 3 to 7 percent by weight methyl methacrylate, (d) from 0.1 to 3 percent by weight styrene, and (e) from 0.1 to 1 percent by weight (meth)acrylic acid, and introducing an initiator to the monomer emulsion, thereby polymerizing the monomer mixture to form an acrylic copolymer suitable for use in a pressure sensitive adhesive composition, wherein the acrylic copolymer has an acid content of less than 1 percent by weight, based on the total weight of the monomers in the monomer mixture.

### DETAILED DESCRIPTION OF THE DISCLOSURE

The instant disclosure relates to water-based pressure sensitive adhesive compositions and methods of making same. The water-based pressure sensitive adhesive compositions disclosed herein exhibit improved adhesion and/or cohesion over a wide range of temperatures, as detailed in the Examples below.

In some embodiments, the acrylic copolymer is formed via radical polymerization, e.g., emulsion polymerization. The end result is an acrylic emulsion including a dispersion of acrylic copolymer particles in the aqueous medium, the polymer particles comprising constituent units each being derived from a particular monomer in a monomer mixture which is fed to a reactor over a period of time and polymerized. As used herein, “copolymer” refers to a polymer in which two or more different types of monomers are joined in the same polymer chain.

In some embodiments, preparation of the adhesive compositions by emulsion polymerization takes place by initially charging an aqueous phase to a polymerization reactor and then feeding in the monomer mixture to be polymerized. The aqueous initial charge typically includes, in addition to water, a salt. In some embodiments, examples of suitable surfactants for use according this disclosure include, but are not limited to, cationic surfactants, anionic surfactants, zwitterionic surfactants, non-ionic surfactants, and combinations thereof

Before beginning the feed of the monomer mixture, the aqueous initial charge is heated to a temperature in the range of from 30 to 110° C. Once the desired temperature is reached, the monomer mixture is gradually fed to the polymerization reactor over a period of time in the presence of a free-radical polymerization initiator.

In some embodiments, the initiator can be either a thermal initiator or a redox system initiator. Example of thermal initiators include, but are not limited to, sodium persulfate and ammonium persulfate. Where the initiator is a redox system initiator, the reducing agent can be, for example, an ascorbic acid, a sulfoxylate, or an erythorbic acid, while the oxidating agent can be, for example, a peroxide or a persulfate. In some embodiments, the amount of initiator used is less than 0.9 weight percent, based on the total weight of the monomers in the monomer mixture.

In some embodiments, a chain transfer is added during the monomer mixture feeding to control the molecular weight of the produced acrylic copolymer. Examples of chain transfer agents which may be used include long chain alkyl mercaptans such as t-dodecyl mercaptans, methyl 3-mercaptopropionate (“MMP”), alcohols such as isopropanol, isobutanol, lauryl alcohol or t-octyl alcohol, carbon tetrachloride, tetrachloroethylene and trichloro-bromoethane. In some embodiments, the chain transfer agent is methyl-3-mercaptopropionate. In some embodiments, the chain transfer agent is added after about 15 percent by weight, or about 20 percent by weight, or about 25 percent by weight, of the monomer mixture has been fed to the reactor for polymerization.

In some embodiments, additional components can be added during feeding of the monomer mixture. For instance, surfactant (in addition to surfactant in the initial aqueous charge, if present) can be added during the monomer mixture feeding. In some embodiments, the additional surfactant can be added after about 30 percent by weight, or about 35 percent by weight, or about 44 percent by weight, of the monomer mixture has been fed to the reactor for polymerization. The surfactant can be added to, inter alia, control the particle size distribution of the acrylic copolymer particles. In some embodiments, about 5 to 15 percent by weight of the acrylic copolymer particles produced via polymerization have a weight average diameter of 70 to 150 nm, or 80 to 100 nm, with the remainder of the acrylic copolymer particles having a weight average diameter of 300 to 700 nm, or 350 to 450 nm.

In some embodiments, the monomer mixture comprises a monomer having a relatively-low glass transition temperature and a monomer having a relatively-high glass transition temperature. In some embodiments, the monomer having a relatively-low glass transition temperature has a glass transition temperature (or “T_{g}”) of less than or equal to −0° C. as measured by Differential Scanning calorimeter with heating rate of 10° C./min. In some embodiments, the T_{g} of the monomer having a relatively-low glass transition temperature is less than 0° C., such as from −100 to 0° C., or from −75 to −25° C., or from −55 to −45° C. Examples of suitable monomers having relatively-low glass transition temperatures include, but are not limited to, 2-ethylhexyl acrylate, butyl acrylate, isooctyl acrylate and combinations thereof. In some embodiments, the T_{g} of the monomer having a relatively-high glass transition temperature is greater than 20° C., or from 20 to 150° C., or from 75 to 125° C., or from 100 to 115° C. Examples of suitable monomers having relatively-high glass transition temperatures include, but are not limited to, styrene, methyl methacrylate, acrylic acid, and combinations thereof. In some embodiments, the monomer having a relatively-high glass transition temperature is an acid selected from the group consisting of acrylic acid, methacrylic acid, itaconic acid, maleic acid, carboxylic acid, and combinations thereof.

In some embodiments, the monomer mixture comprises, based on the total weight of monomers in the monomer mixture, (a) from 60 to 80 percent by weight, or from 70 to 75 percent by weight, 2-ethylhexyl acrylate, (b) from 10 to 30 percent by weight, or from 15 to 25 percent by weight, butyl acrylate, (c) from 3 to 7 percent by weight, or from 5 to 6 percent by weight, methyl methacrylate, (d) from 0.1 to 3 percent by weight, or from 0.5 to 1.5 percent by weight, styrene, (e) from 0.1 to 1 percent by weight, or 0.4 to 0.8 percent by weight, or from 0.4 to 0.6 percent by weight, (meth)acrylic acid.

In some embodiments, the acrylic copolymer has a total acid content of less than 1 percent by weight, or less than 0.75 percent by weight, or less than 0.5 percent by weight, based on the total weight of the monomers in the monomer mixture.

In some embodiments, water-based pressure sensitive adhesive composition does not comprise ethyl acrylate. In some embodiments, water-based pressure sensitive adhesive composition does not comprise vinyl acetate. In some embodiments, water-based pressure sensitive adhesive composition does not comprise α-methyl styrene. In some embodiments, water-based pressure sensitive adhesive composition does not comprise any of ethyl acrylate, vinyl acetate, or α-methyl styrene. In some embodiments, water-based pressure sensitive adhesive composition does not comprise a crosslinking agent.

In some embodiments, the acrylic copolymer has a glass transition temperature (or “T_{g}”) of less than or equal to −10° C. as measured by Differential Scanning calorimeter with heating rate of 10° C./min. In some embodiments, the Tg of the acrylic emulsion is from −70 to −10° C., or from −60 to −30° C., or from −55 to −45° C.

In some embodiments, the water-based pressure sensitive adhesive composition may further include, optionally, one or more additives. Examples of the one or more additives include, but are not limited to, a thickener, a defoamer, a wetting agent, a mechanical stabilizer, a pigment, a filler, a freeze-thaw agent, a neutralizing agent, a plasticizer, a tackifier, an adhesion promoter, and combinations thereof.

The water-based pressure sensitive adhesive composition may comprise 0 to 5 percent by weight of a thickener, based on the total weight of the adhesive composition. All individual values and subranges from 0 to 5 percent by weight are included herein and disclosed herein. For example, the wt % of the neutralizing agent can be from a lower limit of 0, 0.5, or 1 percent by weight to an upper limit of 1, 3, or 5 percent by weight. Example thickeners include, but are not limited to, ACRYSOL™, UCAR™ and CELOSIZE™ which are commercially available from The Dow Chemical Company, Midland, Mich.

The water-based pressure sensitive adhesive composition may comprise 0 to 2 percent by weight of a neutralizing agent, based on the total weight of the adhesive composition. All individual values and subranges from 0 to 2 percent by weight are included herein and disclosed herein. For example, the wt % of the neutralizing agent can be from a lower limit of 0, 0.3, or 0.5 percent by weight to an upper limit of 0.5, 1, or 2 percent by weight. Neutralizing agents are typically used to control pH to provide stability to the formulated pressure sensitive adhesive composition. Examples of the neutralizing agent include, but are not limited to, aqueous ammonia, aqueous amines, and other aqueous inorganic bases.

The water-based pressure sensitive adhesive composition may comprise less than 50 percent by weight of a tackifier, based on the total weight of the adhesive composition. All individual values and subranges from less than 50 percent by weight are included herein and disclosed herein. For example, the content of the tackifier can be from a lower limit of 0, 0.1, 0.2, 0.3, 0.5, 1, 2, 3, 4, or 5 percent by weight to an upper limit of 10, 20, 30, 40, or 50 percent by weight. Examples of the tackifier include, but are not limited to, rosin resins including rosin acid and/or rosin ester obtained by esterifying rosin acid with alcohols or an epoxy compound and/or its mixture, non-hydrogenated aliphatic C₅ resins, hydrogenated aliphatic C₅ resins, aromatic modified C₅ resins, terpene resins, hydrogenated C₉ resins, and combinations thereof.

The water-based pressure sensitive adhesive composition may comprise less than 5 percent by weight of an adhesion promoter, based on the total weight of the adhesive composition. All individual values and subranges from less than 5 percent by weight are included herein and disclosed herein. For example, the wt % of the adhesion promoter can be from a lower limit of 0, 0.1, 0.2, 0.3, 0.5, 1, 2, 3, or 4 percent by weight to an upper limit of 0.1, 0.2, 0.3, 0.5, 1, 2, 3, 4, 5 percent by weight.

### Examples of the Disclosure

The present disclosure will now be described in further detail by discussing Illustrative Examples and Comparative Examples (collectively “the Examples”). However, the scope of the present disclosure is not, of course, limited to the Illustrative Examples.

Acrylic Copolymer Preparation

The acrylic copolymers used in the Examples are prepared according to the following procedure. A five liter, four-neck reactor equipped with a condenser, a mechanical stirrer, a temperature-controlled thermocouple and inlets for initiators and monomers, is fed with 480 g of deionized water and heated to 91° C. under a gentle nitrogen flow. In a separate container, a monomer emulsion is prepared by mixing 307 g of deionized water, and about 2,200 grams of a monomer mixture emulsion comprising 50% aqueous sodium hydroxide, 30% aqueous solution of disodium ethoxylated alcohol half-ester of sulfosuccinic acid, and 23% aqueous solution of sodium dodecylbenzene sulfonate, acrylic acid (“AA”), styrene (“STY), 2-ethylhexyl acrylate (“EHA”), butyl acrylate (“BA”), and methyl methacrylate (“MMA”), according to the formulations identified in Table 1.

TABLE 1
Monomer Mixture Feed Compositions (wt
% actives based on total monomer)

| | IE1 | IE2 | IE3 | CE1 | CE2 |
|---|---|---|---|---|---|
| 2-Ethylhexyl acrylate | 73 | 73 | 73 | 73 | 73 |
| n-Butyl acrylate | 20 | 20 | 20 | 20 | 20 |
| Methyl methacrylate | 5.5 | 5.6 | 5.4 | 5 | 5 |
| Styrene | 1 | 1 | 1 | 1 | 1 |
| Acrylic acid | 0.5 | 0.4 | 0.6 | 1 | 1 |
| Sodium hydroxide | 0.01 | 0.01 | 0.01 | 0.02 | 0.02 |
| POLYSTEP ™ A-16-22 | 0.25 | 0.25 | 0.25 | 0.25 | 0.25 |
| AEROSOL ™ A-102 | 0.45 | 0.45 | 0.45 | 0.45 | 0.45 |

The reactor contents are then heated to about 91° C. and a solution of a mixture of 9.8 grams of sodium persulfate and 0.86 grams of sodium carbonate in 52 grams of deionized water and 73 grams of a 30.2% solids latex having a weight average particle diameter of 100 nm (commonly known as a “seed” or “preform seed”) is added into the reactor Immediately after these additions, the monomer mixture emulsion is fed into the reactor.

When 24% of the monomer mixture emulsion has been added to the reactor, 0.98 grams of methyl-3-mercaptopropionate (“MMP”) in 20 grams of deionized water is added to the monomer pre-emulsion. When 44% of the monomer mixture emulsion has been added to the reactor, 24 grams of a 23% aqueous solution of sodium dodecylbenzene sulfonate in 36 grams of deionized water is added to the reactor. Upon completion of the addition of the monomer mixture emulsion to the reactor, 0.018 grams of ferrous sulfate heptahydrate and 0.073 grams of a 14% aqueous solution of copper nitrate in 16 grams deionized water is added to the reactor. The reactor contents are gradually cooled, and un-polymerized monomers are reduced by the gradual addition of 12.3 grams 70% aqueous t-butyl hydroperoxide in 52 grams of deionized water and 6.8 grams sodium sulfoxylate formaldehyde in 74 grams deionized water. 15.8 grams of 30% aqueous ammonia in 16 grams of deionized water is then added to raise the pH of the emulsion.

The emulsions are then formulated by mixing in 0.7% AEROSOL™ OT-75, available from Cytec Solvay Group, and pH adjusted to about 8.0 with the addition of 14% ammonia. The viscosity is then increased by adding standard HASE and/or HEUR thickener to viscosity of about 1,000 cps as measured with an LVT Brookfield viscometer (#3, 30 rpm). In CE2 an additional 10% w/w TACOLYN™ 1070 tackifier, available from Eastman, is added during formulation. The emulsions are then coated onto RP-12 release liner, available from Chemsultants, dried at 80° C. for 5 minutes, and then laminated to a semi-gloss paper face stock (unless otherwise specified), padded, and then stored at about 23° F. at 50% relative humidity for at least 24 hours prior to any testing.

The obtained emulsions have approximately 60 percent by weight solids and a glass transition temperature of about −50° C. The final emulsions have a bimodal particle size distribution, with approximately 5 to 15 percent by weight of the total polymer in the emulsions present in particles having a weight average diameter of 80 to 100 nm, the remainder of the polymer being present in particles having a weight average diameter of 350 to 450 nm.

Application Tests

Adhesion performance is measured according to standard industrial methods (Test Methods for Pressure Sensitive Tapes, 16^{th} edition, Pressure Sensitive Tape Council). Stainless steel shear is measured in a 1″×1″×1 kg configuration, according to PSTC test method #107. Stainless steel peels are measured according to PSTC test method #101. 180° peels are measured at 12″/min Measurements are made in a constant temperature room held within the specifications set by the PSTC test methods. Cold temperature testing is performed within an environmental chamber set at the specified temperatures. HDPE and stainless steel panels for all testing are obtained from Chemsultants. Commercially available polyethylene film substrate is prepared by taping the film to a stainless steel panel with a double sided tape. Cardboard panels are cut from standard cardboard boxes made with 0% recycled content.

Failure modes (“FM”) for the Examples use the following abbreviations: “A” indicating adhesive failure, “C” indicating cohesive failure, “SS” indicating slip stick failure, “Sl.” indicating the modifier “slight,” “FT” indicating fiber tear or pulling fibers off cardboard, and “PT” indicating paper tear. For the peel and loop tack tests, a performance difference greater than 0.5 N is considered significant. Further, a minimum 1 hour shear is desirable.

TABLE 2
Performance Tests for IE1 and CE1

| | | | | CE1 | SD | IE1 | SD |
|---|---|---|---|---|---|---|---|
| Coated | RT | 90° Peel, 1 min | HDPE | 3.0 | 0.1 | 3.4 | 0.3 |
| paper | | dwell | SS | 11.9 | 0.4 | 12.0 | 0.5 |
| | | | CB | 10.1 | 0.4 | 10.4 | 0.3 |
| | | Loop Tack | HDPE | 6.6 | 0.3 | 7.2 | 0.2 |
| | | | SS | 12.2 | 0.2 | 13.7 | 0.1 |
| | | | CB | 11.7 | 0.2 | 12.4 | 0.1 |
| | | Shear | SS | 12.4 | 0.1 | 2.8 | 0.2 |
| | Low | 90° Peel, 1 min | HDPE | 1.0 | 0.1 | 0.8 | 0.0 |
| | Temp. | dwell | SS | 4.1 | 0.2 | 3.7 | 0.3 |
| | −15° C. | | CB | 5.3 | 0.3 | 6.2 | 0.4 |
| | | Loop Tack | HDPE | 1.9 | 0.4 | 1.7 | 0.2 |
| | | | SS | 17.0 | 0.4 | 16.6 | 0.1 |
| | | | CB | 9.0 | 0.2 | 8.8 | 0.4 |
| Direct | RT | 90° Peel, 1 min | HDPE | 3.0 | 0.2 | 3.0 | 0.2 |
| Thermal | | dwell | SS | 10.2 | 0.2 | 11.1 | 0.5 |
| Paper | | | CB | 9.2 | 0.2 | 9.7 | 0.4 |
| | | Loop Tack | HDPE | 6.9 | 0.4 | 7.6 | 0.5 |
| | | | SS | 12.5 | 0.3 | 12.5 | 0.4 |
| | | | CB | 12.6 | 0.4 | 12.3 | 0.3 |
| | | Shear | SS | 11.5 | 0.3 | 3.6 | 0.3 |
| | Low | 90° Peel, 1 min | HDPE | 0.8 | 0.1 | 0.7 | 0.0 |
| | Temp. | dwell | SS | 3.5 | 0.1 | 3.0 | 0.3 |
| | −15° C. | | CB | 5.9 | 0.3 | 7.3 | 0.2 |
| | | Loop Tack | HDPE | 1.9 | 0.5 | 2.4 | 0.5 |
| | | | SS | 8.1 | 0.2 | 10.7 | 0.2 |
| | | | CB | 8.8 | 0.9 | 8.2 | 0.4 |
| PET film | RT | 90° Peel, 1 min | HDPE | 2.0 | 0.1 | 2.6 | 0.3 |
| | | dwell | SS | 10.6 | 0.3 | 12.0 | 0.4 |
| | | | CB | 10.6 | 0.1 | 10.8 | 0.4 |
| | | Loop Tack | HDPE | 6.3 | 0.4 | 6.4 | 0.5 |
| | | | SS | 12.6 | 0.5 | 14.0 | 0.3 |
| | | | CB | 13.6 | 0.4 | 15.5 | 0.5 |
| | | Shear | SS | 4.9 | 0.4 | 2.3 | 0.1 |
| | Low | 90° Peel, 1 mm | HDPE | 0.5 | 0.1 | 0.5 | 0.0 |
| | Temp. | dwell | SS | 1.4 | 0.1 | 1.9 | 0.1 |
| | −15° C. | | CB | 4.5 | 0.1 | 5.0 | 0.2 |
| | | Loop Tack | HDPE | 1.6 | 0.4 | 1.5 | 0.5 |
| | | | SS | 3.5 | 0.3 | 10.8 | 0.4 |
| | | | CB | 4.3 | 0.4 | 8.1 | 0.3 |

As indicated in Table 2, IE1 shows a significant improvement in adhesion over CE1 on multiple facestocks (coated paper, direct thermal paper and PET) without compromising the cohesive strength. Failure modes between IE1 and CE1 are same for each test.

TABLE 3
Performance Tests for IE1 to IE3 and CE1

| | | | | | | | 73.1° F./50.3% RH | | |
|---|---|---|---|---|---|---|---|---|---|
| | | | | | | | | 90° Peel- | |
| | | | 90° Peel @ 10 min dwell-Newton | | | | | GLAD (PE | |
| Sample ID (acid | | 90° Peel-HDPE | | 90° Peel-SS | | 90° Peel-CB | | FILM) | |
| content, wt %) | | FM | Avg | FM | Avg | FM | Avg | FM | Avg |
| IE1 | (0.5%) | A | 4.0 | A sl. C | 11.9 | A/C | 9.3 | A | 4.6 |
| CE1 | (1%) | A | 3.4 | A sl. C | 11.2 | A/C | 8.8 | A | 4.0 |
| IE2 | (0.4%) | A | 4.4 | C | 12.8 | A/C | 8.8 | A | 5.0 |
| IE3 | (0.6%) | A | 3.6 | A sl. C | 11.7 | A/C | 9.5 | A | 4.6 |
| | | Loop Tack- | | | | Loop Tack- | | Loop Tack- | |
| | | HDPE | | Loop Tack-SS | | STA/CB | | GLAD | |
| Sample ID | | FM | Avg | FM | Avg | FM | Avg | FM | Avg |
| IE1 | (0.5%) | A | 7.3 | A | 13.9 | A sl. C | 11.8 | A | 7.4 |
| CE1 | (1%) | A | 7.2 | A | 12.6 | A sl. C | 10.9 | A | 7.0 |
| IE2 | (0.4%) | A | 7.9 | A sl. C | 17.0 | A sl. C | 13.3 | A | 8.2 |
| IE3 | (0.6%) | A | 7.1 | A | 14.0 | A sl. C | 11.3 | A | 7.3 |

| | | Shear-SS-Hours | |
|---|---|---|---|
| Sample ID | | FM | Avg |
| IE1 | (0.5%) | C | 5.0 |
| CE1 | (1%) | C | 5.1 |
| IE2 | (0.4%) | C | 1.0 |
| IE3 | (0.6%) | C | 6.2 |

As indicated in Table 3, IE1, IE2 and IE3 show improved room temperature adhesion over CE1.

TABLE 4
Performance Tests for IE1 to IE3 and CE1

| −°5 C. | | | | | | |
|---|---|---|---|---|---|---|
| Sample | 90° Peel-HDPE | | 90° Peel-STA/CB | | 90° Peel-GLAD | |
| ID | FM | Avg | FM | Avg | FM | Avg |
| IE1 | A/SS | 3.1 | A sl. FT | 6.5 | A/SS | 1.3 |
| CE1 | A/SS | 2.9 | A sl. FT | 5.4 | A/SS | 1.2 |
| IE2 | A/SS | 3.0 | A sl. FT | 6.3 | A/SS | 1.5 |
| IE3 | A/SS | 3.0 | A sl. FT | 5.9 | A/SS | 1.3 |
| Sample | Loop Tack-HDPE | | Loop Tack-STA/CB | | Loop Tack-GLAD | |
| ID | FM | Avg | FM | Avg | FM | Avg |
| IE1 | A/SS | 8.1 | A sl. FT | 11.5 | A/SS | 4.8 |
| CE1 | A/SS | 7.9 | A sl. FT | 10.8 | A/SS | 3.3 |
| IE2 | A/SS | 7.3 | A sl. FT | 12.3 | A/SS | 5.5 |
| IE3 | A/SS | 7.8 | A sl. FT | 10.6 | A/SS | 4.7 |

As indicated in Table 4, IE1 and IE2 show improved adhesion over CE1 at low temperature (refrigerator grade, −5° C.).

TABLE 5
Performance Tests for IE1 to IE3 and CE1

| −°20 C. | | | | | | |
|---|---|---|---|---|---|---|
| Sample | 90° Peel-HDPE | | 90° Peel-STA/CB | | 90° Peel-GLAD | |
| ID | FM | Avg | FM | Avg | FM | Avg |
| IE1 | A/SS | 0.60 | A/FT | 4.59 | A/SS | 0.92 |
| CE1 | A/SS | 0.51 | A sl. SS/FT | 3.81 | A/SS | 0.91 |
| IE2 | A/SS | 0.47 | A sl. SS/FT | 3.90 | A/SS | 1.13 |
| IE3 | A/SS | 0.61 | A sl. SS/FT | 4.01 | A/SS | 1.22 |
| Sample | Loop Tack-HDPE | | Loop Tack-STA/CB | | Loop Tack-GLAD | |
| ID | FM | Avg | FM | Avg | FM | Avg |
| IE1 | A/SS | 1.50 | A sl. SS | 6.53 | A/SS | 2.37 |
| CE1 | A/SS | 0.97 | A sl. SS | 4.60 | A/SS | 1.50 |
| IE2 | A/SS | 1.37 | A | 7.77 | A/SS | 1.90 |
| IE3 | A/SS | 1.67 | A sl. SS | 6.07 | A/SS | 1.43 |

As indicated in Table 5, IE1 and IE2 show improved adhesion over CE1 at low temperature (freezer grade, −20° C.).

TABLE 6
Performance Tests for IE1 and CE2

| | | IE1 | CE2 (1% acid) + |
|---|---|---|---|
| | | (0.5% acid) | 10% Tackifier |
| 90° Peel RT | HDPE (A) | 4.2 | 3.8 |
| | SS | 12.9 A | 9.6 A sl. C |
| | CB (A/C) | 8.0 | 7.6 |
| Loop tack RT | HDPE (A) | 8.6 | 7.5 |
| | SS (A) | 16.5 | 11.0 |
| | CB (A) | 10.4 | 11.6 |
| 90° Peel −5° C. | HDPE (A/SS) | 5.7 | 7.2 |
| | SS | PT | PT |
| | CB (A/FT) | FT | 8.2 |
| Loop tack −5° C. | HDPE | 11.1 A/SS | 14.8 A |
| | SS | 20.3 A | 22.5 A/PT |
| | CB (A/FT) | 16.6 | 16.7 |
| 90° Peel −20° C. | HDPE | 6.3 A | 3.8 A/SS |
| | SS | PT | PT |
| | CB | A/FT PT | A/FT PT |
| Loop tack −20° C. | HDPE (A/SS) | 2.1 | 1.8 |
| | SS (A/SS) | 13.1 | 9.3 |
| | CB (A/sl. FT) | 13.0 | 8.1 |
| RT, SS | Shear | 6.8 | 24.3 |

As indicated in Table 6, IE1 shows overall improved adhesion over CE2 at both room as well as low temperature. PT or FT are desirable failure modes.

In addition to the embodiments described above and those set forth in the Examples, many embodiment of specific combinations are within the scope of the disclosure, some of which are described below:

### Embodiment 1

A pressure sensitive adhesive composition, comprising:
an acrylic copolymer formed from a monomer mixture comprising, based on the total weight of monomers in the monomer mixture:
   (a) from 60 to 80 percent by weight 2-ethylhexyl acrylate;
   (b) from 10 to 30 percent by weight butyl acrylate;
   (c) from 3 to 7 percent by weight methyl methacrylate;
   (d) from 0.1 to 3 percent by weight styrene;
   (e) from 0.1 to 1 percent by weight (meth)acrylic acid,
wherein the acrylic copolymer has an acid content of less than 1 percent by weight, based on the total weight of the monomers in the monomer mixture.

### Embodiment 2

The pressure sensitive adhesive composition of any preceding or succeeding Embodiment, wherein the composition does not comprise ethyl acrylate.

### Embodiment 3

The pressure sensitive adhesive composition of any preceding or succeeding Embodiment, wherein the composition does not comprise vinyl acetate.

### Embodiment 4

The pressure sensitive adhesive composition of any preceding or succeeding Embodiment, wherein the composition does not comprise α-methyl styrene.

### Embodiment 5

The pressure sensitive adhesive composition of any preceding or succeeding Embodiment, wherein the composition does not comprise ethyl acrylate, vinyl acetate, or α-methyl styrene.

### Embodiment 6

The pressure sensitive adhesive composition of any preceding or succeeding Embodiment, wherein the composition does not comprise a crosslinking agent.

### Embodiment 7

The pressure sensitive adhesive composition of any preceding or succeeding Embodiment, wherein the monomer mixture comprises 70 to 75 percent by weight 2-ethylhexyl acrylate.

### Embodiment 8

The pressure sensitive adhesive composition of any preceding or succeeding Embodiment, wherein the monomer mixture comprises 15 to 25 percent by weight butyl acrylate.

### Embodiment 9

The pressure sensitive adhesive composition of any preceding or succeeding Embodiment, wherein the monomer mixture comprises 5 to 6 percent by weight methyl methacrylate.

### Embodiment 10

The pressure sensitive adhesive composition of any preceding or succeeding Embodiment, wherein the monomer mixture comprises 0.5 to 1.5 percent by weight styrene.

### Embodiment 11

The pressure sensitive adhesive composition of any preceding or succeeding Embodiment, wherein the monomer mixture comprises 0.4 to 0.8 percent by weight acrylic acid.

### Embodiment 12

The pressure sensitive adhesive composition of any preceding or succeeding Embodiment, wherein the monomer mixture comprises 0.4 to 0.6 percent by weight acrylic acid.

### Embodiment 13

The pressure sensitive adhesive composition of any preceding or succeeding Embodiment, wherein the monomer mixture comprises less than 0.75 percent by weight acrylic acid.

### Embodiment 14

The pressure sensitive adhesive composition of any preceding or succeeding Embodiment, wherein the monomer mixture comprises less than 0.5 percent by weight acrylic acid.

### Embodiment 15

The pressure sensitive adhesive composition of any preceding or succeeding Embodiment, further comprising a thickener, a defoamer, a wetting agent, a mechanical stabilizer, a pigment, a filler, a freeze-thaw agent, a neutralizing agent, a plasticizer, a tackifier, an adhesion promoter, and combinations thereof.

### Embodiment 16

The pressure sensitive adhesive composition of any preceding or succeeding Embodiment, further comprising an acid selected from the group consisting of methacrylic acid, itaconic acid, maleic acid, carboxylic acid, and combinations thereof.

### Embodiment 17

The pressure sensitive adhesive composition of any preceding or succeeding Embodiment, wherein the glass transition temperature of the acrylic copolymer is from −55 to −45° C.

### Embodiment 18

A pressure sensitive adhesive composition, comprising:
an acrylic copolymer comprising, in a polymerized form:
   a monomer having a relatively-low glass transition temperature of less than 0° C.;
   a monomer having a relatively-high glass transition temperature of not less than 100° C.,
   wherein the acrylic copolymer has an acid content of less than 1 percent by weight, based on the total weight of the monomers forming the acrylic copolymer.

### Embodiment 19

The pressure sensitive adhesive composition of any preceding or succeeding Embodiment, wherein the monomer having a relatively-low glass transition temperature is selected from the group consisting of 2-ethylhexyl acrylate, butyl acrylate, isooctyl acrylate, and combinations thereof.

### Embodiment 20

The pressure sensitive adhesive composition of any preceding or succeeding Embodiment, wherein the monomer having a relatively-high glass transition temperature is selected from the group consisting of styrene, methyl methacrylate, acrylic acid, and combinations thereof.

### Embodiment 21

The pressure sensitive adhesive composition of any preceding or succeeding Embodiment, wherein the monomer having a relatively-high glass transition temperature is an acid selected from the group consisting of acrylic acid, methacrylic acid, itaconic acid, maleic acid, carboxylic acid, and combinations thereof.

### Embodiment 22

A method for preparing a pressure sensitive adhesive composition, comprising:
preparing a monomer emulsion by dispersing a monomer mixture and a surfactant in an aqueous medium, the monomer mixture, based on the total weight of monomers in the monomer mixture, (a) from 60 to 80 percent by weight 2-ethylhexyl acrylate, (b) from 10 to 30 percent by weight butyl acrylate, (c) from 3 to 7 percent by weight methyl methacrylate, (d) from 0.1 to 3 percent by weight styrene, and (e) from 0.1 to 1 percent by weight (meth)acrylic acid; and
introducing an initiator to the monomer emulsion, thereby polymerizing the monomer mixture to form an acrylic copolymer suitable for use in a pressure sensitive adhesive composition,
wherein the acrylic copolymer has an acid content of less than 1 percent by weight, based on the total weight of the monomers in the monomer mixture.

### Embodiment 23

A pressure sensitive adhesive composition, comprising:
an acrylic copolymer formed from a monomer mixture comprising, based on the total weight of monomers in the monomer mixture:
   (a) from 60 to 80 percent by weight 2-ethylhexyl acrylate;
   (b) from 10 to 30 percent by weight butyl acrylate;
   (c) from 3 to 7 percent by weight methyl methacrylate;
   (d) from 0.1 to 3 percent by weight styrene;
   (e) from 0.1 to 1 percent by weight an acid selected from the group consisting of (meth)acrylic acid, itaconic acid, maleic acid, carboxylic acid, and combinations thereof,
wherein the acrylic copolymer has an acid content of less than 1 percent by weight, based on the total weight of the monomers in the monomer mixture.

1. A pressure sensitive adhesive composition, comprising:
an acrylic copolymer formed from a monomer mixture comprising, based on the total weight of monomers in the monomer mixture:
(a) from 60 to 80 percent by weight 2-ethylhexyl acrylate;
(b) from 10 to 30 percent by weight butyl acrylate;
(c) from 3 to 7 percent by weight methyl methacrylate;
(d) from 0.1 to 3 percent by weight styrene;
(e) from 0.1 to 1 percent by weight (meth)acrylic acid,
wherein the acrylic copolymer has an acid content of less than 1 percent by weight, based on the total weight of the monomers in the monomer mixture.

2. The pressure sensitive adhesive composition of claim 1, wherein the composition does not comprise ethyl acrylate, vinyl acetate, or α-methyl styrene.

3. The pressure sensitive adhesive composition of claim 1, wherein the composition does not comprise a crosslinking agent.

4. The pressure sensitive adhesive composition of claim 1, further comprising an acid selected from the group consisting of methacrylic acid, itaconic acid, maleic acid, carboxylic acid, and combinations thereof.

5. The pressure sensitive adhesive composition of claim 1, wherein the glass transition temperature of the acrylic copolymer is from −55 to −45° C.

6. A pressure sensitive adhesive composition, comprising:
an acrylic copolymer comprising, in a polymerized form:
a monomer having a relatively-low glass transition temperature of less than 0° C.;
a monomer having a relatively-high glass transition temperature of not less than 100° C.,
wherein the acrylic copolymer has an acid content of less than 1 percent by weight, based on the total weight of the monomers forming the acrylic copolymer.

7. The pressure sensitive adhesive composition of claim 6, wherein the monomer having a relatively-low glass transition temperature is selected from the group consisting of 2-ethylhexyl acrylate, butyl acrylate, isooctyl acrylate, and combinations thereof.

8. The pressure sensitive adhesive composition of claim 7, wherein the monomer having a relatively-high glass transition temperature is selected from the group consisting of styrene, methyl methacrylate, acrylic acid, and combinations thereof.

9. The pressure sensitive adhesive composition of claim 7, wherein the monomer having a relatively-high glass transition temperature is an acid selected from the group consisting of acrylic acid, methacrylic acid, itaconic acid, maleic acid, carboxylic acid, and combinations thereof.

10. A method for preparing a pressure sensitive adhesive composition, comprising:
preparing a monomer emulsion by dispersing a monomer mixture and a surfactant in an aqueous medium, the monomer mixture, based on the total weight of monomers in the monomer mixture, (a) from 60 to 80 percent by weight 2-ethylhexyl acrylate, (b) from 10 to 30 percent by weight butyl acrylate, (c) from 3 to 7 percent by weight methyl methacrylate, (d) from 0.1 to 3 percent by weight styrene, and (e) from 0.1 to 1 percent by weight (meth)acrylic acid; and
introducing an initiator to the monomer emulsion, thereby polymerizing the monomer mixture to form an acrylic copolymer suitable for use in a pressure sensitive adhesive composition,
wherein the acrylic copolymer has an acid content of less than 1 percent by weight, based on the total weight of the monomers in the monomer mixture.
